(19) United States
(12) Patent Application Publication
(10) Pub. No.: US 2007/0200957 A1
(43) Pub. Date: Aug. 30, 2007

(54) METHOD AND APPARATUS FOR IMPROVING TRANSIENT CHARACTERISTIC OF CHROMINANCE SIGNAL

(76) Inventor: YONG-HOON SIM, Seoul (KR)

Correspondence Address: F. CHAU & ASSOCIATES, LLC, 130 WOODBURY ROAD, WOODBURY, NY, 11797, US

(21) Appl. No.: 11/678,869

(22) Filed: Feb. 26, 2007

(30) Foreign Application Priority Data
Feb. 27, 2006 (KR) 10-2006-0018880

(51) Int. Cl. H04N 5/21

(52) U.S. Cl. 348/631

(57) ABSTRACT

A method and apparatus for improving the transition characteristic of a chrominance signal. The method and apparatus generate an edge-improved chrominance signal using a differential signal of a luminance signal and a differential signal of the chrominance signal and generate a transition-improved chrominance signal by removing an undershoot and overshoot of the edge-improved chrominance signal.

### CROSS-REFERENCE TO RELATED PATENT APPLICATION

This application claims the benefit of Korean Patent Application No. 10-2006-0018880, filed on Feb. 27, 2006, in the Korean Intellectual Property Office the disclosure of which is incorporated herein in its entirety by reference.

### BACKGROUND OF THE INVENTION

1. Technical Field

The present disclosure relates to a method and apparatus for improving the transient characteristic of a chrominance signal and, more particularly, to a method and apparatus for generating a chrominance signal with an improved edge characteristic using a differential signal of a luminance signal and a differential signal of a chrominance signal and generating a chrominance signal with an improved transient characteristic by removing undershoot and overshoot of the chrominance signal with the improved edge characteristic.

2. Discussion of Related Art

An image signal corresponding to an image obtained by photography an object using a photographic device is modulated and then transmitted to a display device through a wired or wireless channel. The display device demodulates the image signal to restore the image corresponding to the image signal and displays the image on a screen.

R, G and B signals generated by a photographic device are converted into Y and C signals according to the type of image signal transmitting system being used, and the signals are transmitted to a display device such as a color TV system. The Y signal represents a luminance signal and the C signal represents a chrominance signal.

The transient characteristic of the chrominance signal is slower than that of the luminance signal, because the radio frequency band in the transmission band of the chrominance signal is restricted compared to that of the luminance signal.

FIG. 1 illustrates the transient characteristics of the luminance signal Y and the chrominance signal C. In FIG. 1, the luminance signal Y and the chrominance signal C have rising transient characteristics.

Referring to FIG. 1, the transition of the chrominance signal C is gentler than the transition of the luminance signal Y, which means that the transition time of the chrominance signal C is longer than that of the luminance signal Y.

When an image signal has a long transition time, the sharpness of an image corresponding to the image signal is decreased and, thus, the edge of the image cannot be properly represented. Accordingly, various transition improvement techniques have been proposed for improving the sharpness of an image by increasing the transient slope of the image signal corresponding to the image and reducing the transition time of the image signal. A technique of improving the transient characteristic of the luminance signal is referred to as a luminance transient improvement (LTI) technique, and a technique of improving the transient characteristic of the chrominance signal is referred to as a chrominance transient improvement (CTI) technique. These transient improvement techniques improve the edge characteristic of image signals.

U.S. Patent Application Publication No. 2003/0206245 A1 entitled “Method and apparatus for adjusting color edge center in color transient improvement” discloses the CTI technique.

FIG. 2 is a diagram for explaining the improvement, of the edge characteristic of the chrominance signal. In FIG. 2, C represents the original chrominance signal and C_ei1 and C_ei2 represent chrominance signals with improved edge characteristics.

To obtain the chrominance signals C_ei1 and Cei2 with improved edge characteristics, a first order differential signal and a second order differential signal of the original chrominance signal C are generated. The first order differential signal is multiplied by the second order differential signal and then the resultant signal is multiplied by a predetermined gain constant. The resultant signal is added to the original chrominance signal C to obtain the chrominance signals C_ei1 and C_ei2 with improved edge characteristics. Degrees of improvement of the edge characteristics depend on the gain constant.

The chrominance signal C_ei1 has a transient slope steeper than the original chrominance signal C. The chrominance signal C_ei2 includes an undershoot and overshoot, however, even though it has a transient slope steeper than the original chrominance signal C. When the predetermined gain constant is increased, the transient slope is increased but the undershoot and overshoot are also increased. The undershoot and overshoot may improve the sharpness of an image but excessive undershoot and overshoot distort the original image and deteriorate the picture quality.

Furthermore, the aforementioned edge improvement technique improves the edge characteristic of the chrominance signal using only the chrominance signal without considering the correlation of the luminance signal Y and the chrominance signal C. In this case, an unnatural image may by obtained due to disharmony between the luminance signal Y and the chrominance signal C with improved edge characteristic.

### SUMMARY OF THE INVENTION

Exemplary embodiments of the present invention provide a method and apparatus for generating a chrominance signal having improved edge characteristic using both a improved transient characteristic by removing undershoot and overshoot of the chrominance signal having the improved edge characteristic.

According to an exemplary embodiment of the present invention, there is provided a method of receiving an image signal including a luminance signal and a chrominance signal and outputting a transition-improved chrominance signal, the method including: carrying out multiplication on the sign value of a first order differential signal of the luminance signal, the sign value of a second order differential signal of the luminance signal, a first order differential signal of the chrominance signal and a gain constant to generate an edge chrominance signal; adding the edge chrominance signal and the chrominance signal to generate an edge-improved chrominance signal; detecting a minimum value of the chrominance signal from a predetermined portion of a positive section of a second order differential signal of the chrominance signal, outputting the minimum value, as the value of the transition-improved chrominance signal in a section of the waveform where the value of the edge-improved chrominance signal is lower than the minimum value, and outputting the edge-improved chrominance signal as the transition-improved chrominance signal in a section where the value of the edge-improved chrominance signal is higher than the minimum value; and detecting a maximum value of the chrominance signal from a predetermined portion of a negative section of the second order differential signal of the chrominance signal, outputting the maximum value as the value of the transition-improved chrominance signal in a section of the waveform where the value of the edge-improved chrominance signal is higher than the maximum value, and outputting the edge-improved chrominance signal as the transition-improved chrominance signal is a section of the waveform where the value of the edge-improved chrominance signal is lower than the maximum value.

The gain constant may be controlled according to a degree of the edge improvement of the chrominance signal.

The predetermined portion of the positive section of the second order differential signal of the chrominance signal may be determined according to the characteristics of the luminance signal and the chrominance signal and the gain constant.

The predetermined portion of the negative section of the second order differential value of the chrominance signal may be determined according to the characteristics of the luminance signal and the chrominance signal and the gain constant.

A discrete point of the edge chrominance signal may correspond to the point of inflection of the chrominance signal.

According to an exemplary embodiment of the present invention, there is provided an apparatus receiving an image signal including a luminance signal and a chrominance signal and outputting a transition-improved chrominance signal, the apparatus including a first differentiator generating a first order differential signal of the luminance signal and a first order differential signal of the chrominance signal; a second differentiator generating a second order differential signal of the luminance signal and a second order differential signal of the chrominance signal; and edge chrominance signal generator carrying out multiplication on the sign value of the first order differential signal of the luminance signal, the sign value of the second order differential signal of the luminance signal, the first order differential signal of the chrominance signal and a gain constant to generate an edge chrominance signal; an edge-improved chrominance signal generator adding together the edge chrominance signal and the chrominance signal to generate an edge-improved chrominance signal; a chrominance signal minimum value detector detecting a minimum value of the chrominance signal from a positive section of a second order differential signal of the chrominance signal; a chrominance signal maximum value detector detecting a maximum value of the chrominance signal from a negative section of the second order differential signal of the chrominance signal; and a transition-improved chrominance signal generator clamping the edge-improved chrominance signal to generate the transition-improved chrominance signal having a value between the minimum value and the maximum value of the chrominance signal.

In the positive section of the second order differential signal of the chrominance signal, the transition-improved chrominance signal generator may output the minimum value as the value of the transition-improved chrominance signal in a section where the value of the edge-improved chrominance signal is lower than the minimum value and output the edge-improved chrominance signal as the transition-improved chrominance signal in a section where the value of the edge-improved chrominance signal is higher than the minimum value.

In the negative section of the second order differential signal of the chrominance signal, the transition-improved chrominance signal generator may output the maximum value as the value of the transition-improved chrominance signal in a section where the value of the edge-improved chrominance signal is higher than the maximum value and output the edge-improved chrominance signal as the transition-improved chrominance signal in a section where the value of the edge-improved chrominance signal is lower than the maximum value.

The method and apparatus according to exemplary embodiments of the present invention can be applied to the case where both the luminance signal and the chrominance signal have a rising transient slope, to the case where the luminance signal has a rising transient slope and the chrominance signal has a falling transient slope, to the case where the luminance signal has a falling transient slope and the chrominance signal has a rising transient slope, and to the case where both the luminance signal and the chrominance signal have a falling transient slope.

### BRIEF DESCRIPTION OF THE DRAWINGS

Exemplary embodiments of the present invention will he understood in more detail from the following descriptions taken in conjunction with the attached drawings in which:

FIG. 1 illustrates the transient characteristics of a luminance signal and a chrominance signal;

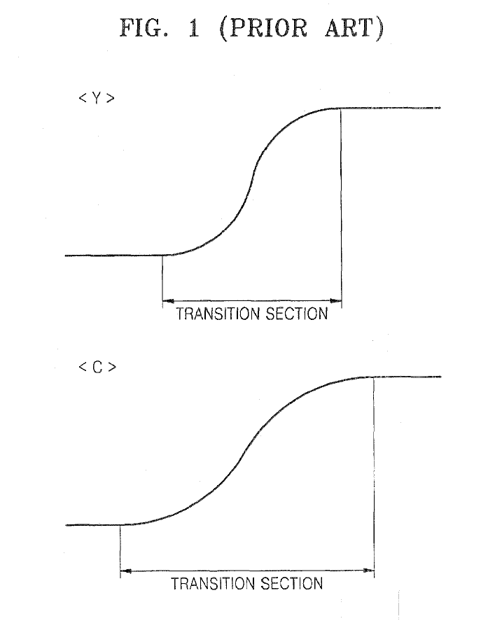

FIG. 2 is a diagram for explaining the improvement of the edge characteristic of a chrominance signal;

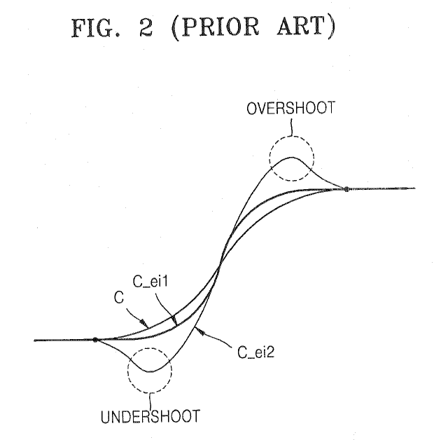

FIG. 3 is a flow chart of an image signal processing method according to an exemplary embodiment of the present invention;

FIG. 4 is a diagram for explaining a step of generating an edge chrominance signal of FIG. 3;

FIG. 5 is a diagram for explaining an edge chrominance signal in response to transition types of a luminance signal and a chrominance signal;

FIG. 6 is a diagram for explaining a step of generating an edge-improved chrominance signal;

FIGS. 7A and 7B are diagrams for explaining a step of clamping an edge-improved chrominance signal to generate a transition-improved chrominance signal; and

FIG. 8 is a block diagram of image signal processing apparatus according to an exemplary embodiment of the present invention.

### DETAILED DESCRIPTION OF THE EXEMPLARY EMBODIMENTS

The present invention will now be described more fully with reference to the accompanying drawings, in which exemplary embodiments of the invention are shown. The invention may, however, be embodied in many different forms and should not be construed as being limited to the exemplary embodiments set forth herein; rather, these exemplary embodiments are provided so that this disclosure will be thorough and complete, and will fully convey the concept of the invention to those skilled in the art. Throughout the drawings, like reference numerals refer to like elements.

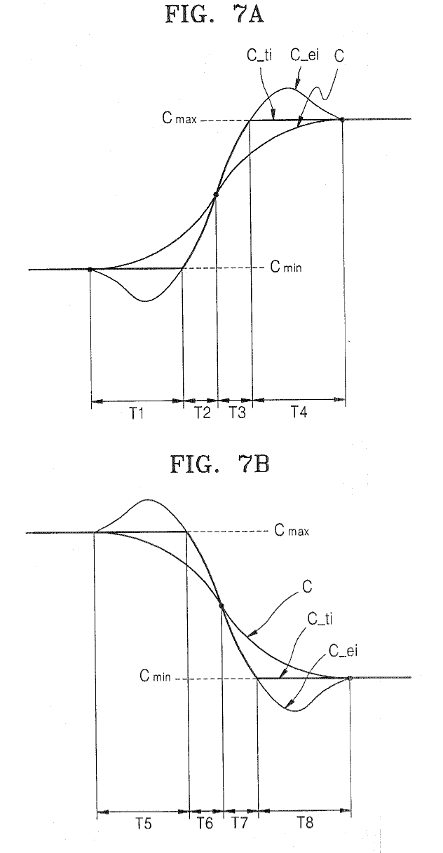

In the following description, the improvement of an edge characteristic means that the transient slope of an image signal is improved and the improvement of a transient characteristic means that the transient slope of an image signal is improved and an undershoot and overshoot are removed. This is reflected in the terms “edge-improved chrominance signal (C_ei of FIGS. 7A and 7B)” and “transition-improved chrominance signal (C_ti of FIGS. 7A and 7B)”.

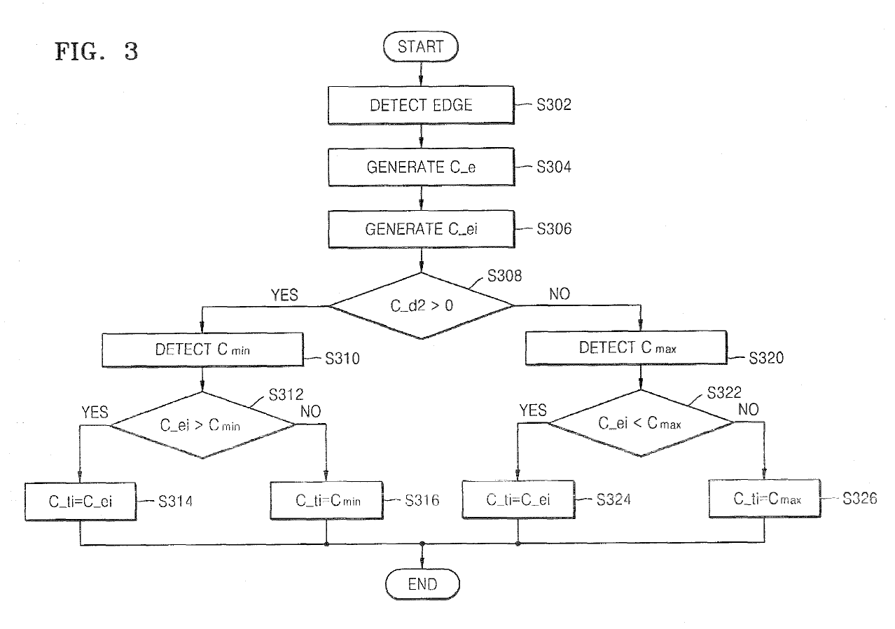

FIG. 3 is a flow chart of an image signal processing method according to an exemplary embodiment of the present invention. The image signal processing method will now be explained with reference to FIGS. 3, 4, 5, 6, 7A and 7B.

An image signal including a luminance signal Y and a chrominance signal C is received, and it is detected whether an image corresponding to the luminance signal Y has a luminance edge and an image corresponding to the chrominance signal C has a chrominance edge in the step S302 of FIG. 3. It is assumed that the image corresponding to the luminance signal Y has the luminance edge when the luminance signal Y has a rising transient slope or a falling transient slope and the image corresponding to the chrominance signal has the chrominance edge when the chrominance signal C has a rising transient slope or a falling transient slope.

The image signal processing method according to an exemplary embodiment of the present invention improves the edge chrominance of the chrominance signal C using both the luminance signal Y and the chrominance signal C, which is distinguished from the conventional image signal processing method in that the edge characteristic of the chrominance signal C is improved using only the chrominance signal C. To accomplish this, the image signal processing method according to an exemplary embodiment of the present invention detects the luminance edge as well as the chrominance edge. Disharmony between the luminance signal Y and the edge-improved chrominance signal can be prevented by improving the edge characteristic of the chrominance signal C using the luminance signal Y correlated with the chrominance signal C.

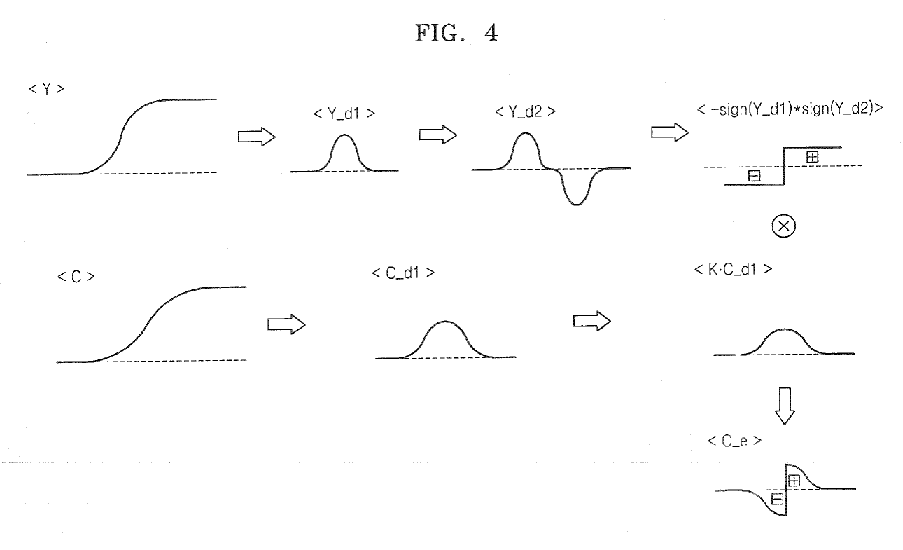

When the luminance edge and the chrominance edge are detected, and edge chrominance signal C_e is generated in the step S304 of FIG. 3. FIG. 4 is a diagram for explaining the step of generating the edge chrominance signal C_e.

Referring to FIG. 4, a first order differential signal Y_d1 and a second order differential signal Y_d2 of the luminance signal Y are obtained. Then, multiplication is carried out on the sign value (Y_d1) of the first order differential signal Y_d1, the sign value (Y_d2) of the second order differential signal Y_d2 and a first constant (−1 in FIG. 4) to generate a first processing signal <−sign (Y_d1)*sign (Y_d2)>.

Subsequently, a first order differential signal C_d1 of the chrominance signal C is obtained and the first order differential signal C_d1 is multiplied by a second constant K to generate a second processing signal <K·C_d1>. Then, tie first processing signal <−sign (Y_d1)*sign (Y_d2)> is multiplied by the second processing signal <K·C_d1> to generate the edge chrominance signal C_e.

While FIG. 4 illustrates that both the luminance signal Y and the chrominance signal C have a rising transient slope, the present invention is not limited thereto. That is, the present invention can be applied to the case where both the luminance signal Y and the chrominance signal C have a rising transient slope, the case where the luminance signal Y has a rising transient slope and the chrominance signal C has a falling transient slope, the case where the luminance signal Y has a falling transient slope and the chrominance signal C has a rising transient slope, and the case where both the luminance signal Y and the chrominance signal C have a falling transient slope.

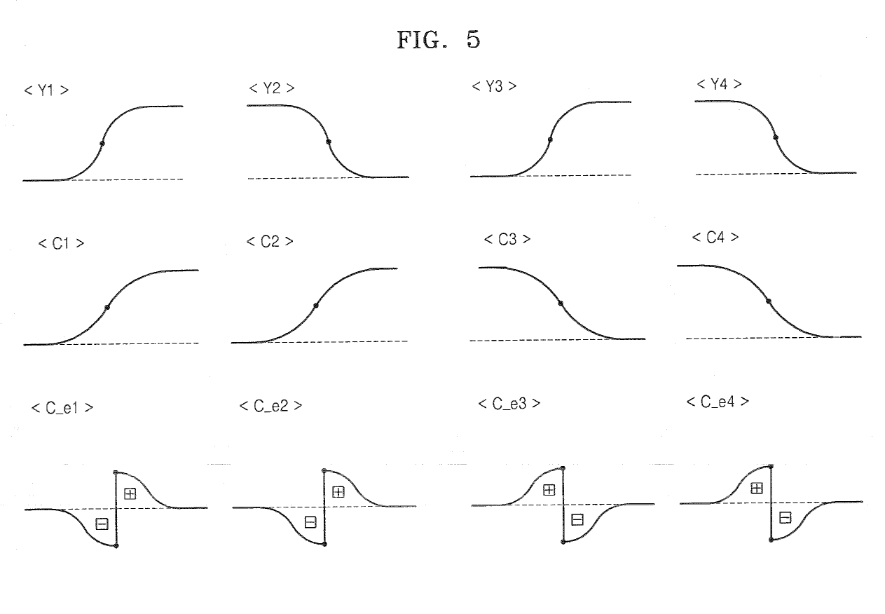

FIG. 5 is a diagram for explaining types of the edge chrominance signal C_e in response to transient types of the luminance signal Y and the chrominance signal C. As illustrated in FIG. 5, all edge chrominance signal C_e1 is generated when both a luminance signal Y1 and a chrominance signal C1 have a rising transient slope, and an edge chrominance signal C_e2 is generated when a luminance signal Y2 has a falling transient slope and a chrominance signal C2 has a rising transient slope. An edge chrominance signal C_e3 is generated when a luminance signal Y3 has a rising transient slope and a chrominance signal C3 has a falling transient slope, and all edge chrominance signal C_e4 is generated when both a luminance signal Y4 and a chrominance signal C4 have a falling transient slope.

As illustrated in FIGS. 4 and 5, the edge chrominance signal C_e is generated by carrying out multiplication on the sign value (Y_d1) of the first order differential signal Y_d1 of the luminance signal Y, the sign value (Y_d2) of the second order differential signal Y_d2 of the luminance signal Y, the first order differential signal C_d1 of the chrominance signal C and a gain constant.

In the case of FIG. 4, the gain constant −K is obtained by multiplying the first constant −1 by the second constant K. The gain constant is controlled according to the degree of edge improvement of the chrominance signal C. As the gain constant increases, the edge characteristic is improved but the undershoot and overshoot also increase.

When the edge chrominance signal C_e is generated, and edge-improved chrominance signal C_ei is generated in the step S306 of FIG. 3.

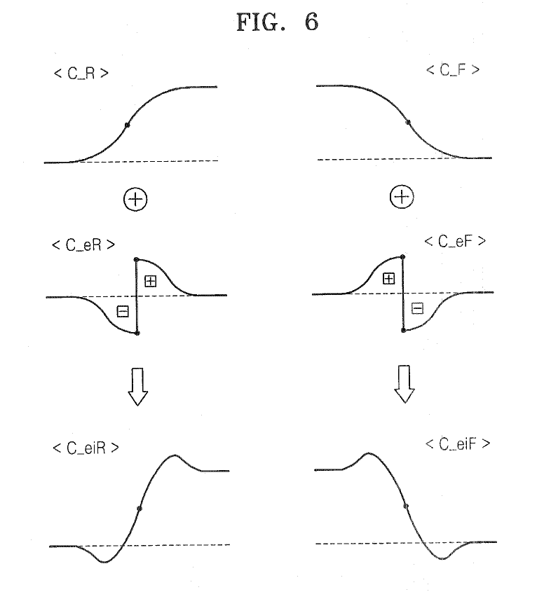

FIG. 6 is a diagram for explaining the step of generating the edge-improved chrominance signal C_ei of FIG. 3. The edge-improved chrominance signal C_ei is generated by adding the edge chrominance signal C_e and the chrominance signal C. A rising chrominance signal C_R is added to an edge chrominance signal C_eR for rising transition improvement to generate an edge-improved chrominance signal C_eiR. A falling chrominance signal C_F is added to an edge chrominance signal C_eF for falling transition improvement to generate an edge-improved chrominance signal C_eiF.

FIG. 6 illustrates that discrete points of the edge chrominance signals C_eR and C_eF respectively correspond to points of inflection of the chrominance signals C_R and C_F.

FIGS. 7A and 7B are diagrams for explaining a step of clamping the edge-improved chrominance signal C_ei to generate a transition-improved chrominance signal C_ti. FIG. 7A illustrates a rising chrominance signal C and FIG. 7B illustrates a falling chrominance signal C. In FIGS. 7A and 7B, the chrominance signal C represents the original chrominance signal, the edge-improved chrominance signal C_ei represents a chrominance signal obtained by improving the edge characteristic of the original chrominance signal, and a transition-improved chrominance signal C_ti represents a signal obtained by removing the undershoot and overshoot of the edge-improved chrominance signal C_ei.

In step S308 of FIG. 3 it is determined whether the second order differential signal of the chrominance signal C is positive or negative. Then, in step S310 of FIG. 3, a minimum value Cmin of the chrominance signal C is detected from a predetermined portion of a positive section of the second order differential signal of the chrominance signal C. In this exemplary embodiment, the minimum value Cmin is detected because the curve of the chrominance signal C is convex downward in the positive section of the second order differential signal of the chrominance signal C.

The predetermined portion of the positive section of the second order differential signal of the chrominance signal is determined according to the characteristics of the luminance signal Y and the chrominance signal C and the gain constant (−K in FIG. 4). In FIGS. 7A and 7B, the predetermined portion corresponds to the positive section (T1 and T2 of FIG. 7A and 7B and T8 of FIG. 7B) of the second order differential signal of the chrominance signal C.

In step S312 of FIG. 3, it is determined whether the value of the edge-improved chrominance signal C_ei is higher than the minimum value Cmin. In step S316 of FIG. 3, the minimum value Cmin is output as the transition-improved chrominance signal C_ti in a section (T1 of FIG. 7A and T8 of FIG. 7B) where the value of the edge-improved chrominance signal C_ei is lower than the minimum Cmin. In step 5314 of FIG. 3, the edge-improved chrominance signal C_ei is output as the transition-improved chrominance signal C_ti in a section (T2 of FIG. 7A and T7 of FIG. 7B) where the value of the edge-improved chrominance signal C_ei is higher than the minimum value Cmin.

When the second order differential signal of the chrominance signal C is negative in step S308 of FIG. 3, a maximum value Cmax of the chrominance signal C is detected from a predetermined portion of a negative section of the second order differential signal of the chrominance signal C in step S520 of FIG.3. In this exemplary embodiment, the maximum value Cmax is detected because the curve of the chrominance signal C is convex upward in the negative section of the second order differential value of the chrominance signal C.

The predetermined portion of the negative section of the second order differential signal of the chrominance signal C is determined according to the characteristics of the luminance signal Y and the chrominance signal C and the gain constant (−K in FIG. 4). In FIGS. 7A and 7B, the predetermined portion corresponds to the negative section (T3 and T4 of FIG. 7A and T5 and T6 of FIG. 7B) of the second order differential signal of the chrominance signal C.

In step S322 of FIG. 3, it is determined whether the value of the edge-improved chrominance signal C_ei is lower than the maximum value Cmax. In step S326 of FIG. 3, the maximum value Cmax is output as the value of the transition-improved chrominance signal C_ti in a section (T4 of FIG. 7, and T5 of FIG. 7B) where the value of the edge-improved chrominance signal C_ei is higher than the maximum value Cmax. In step S324 of FIG. 3, the edge-improved chrominance signal C_ei is output as the transition-improved chrominance signal C_ti in a section (T3 of FIG. 7A and T6 of FIG. 7B) where the value of the edge-improved chrominance signal C_ei is lower the maximum value Cmax.

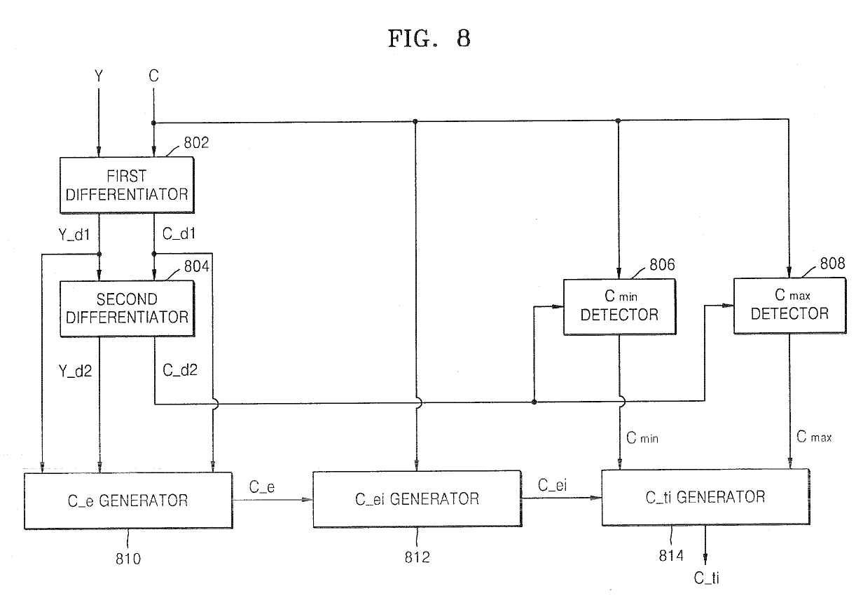

FIG. 8 is a block diagram of an image signal processing apparatus according to an exemplary embodiment of the present invention. The image processing apparatus includes a first differentiator 802, a second differentiator 804 a chrominance signal minimum value detector 806, a chrominance signal maximum value detector 808, an edge chrominance signal generator 810, and edge-improved chrominance signal generator 812 and a transition-improved chrominance signal generator 814.

The first differentiator 802 generates a first order differential signal Y_d1 of a luminance signal Y and a first order differential signal C_d1 of a chrominance signal C. The second differentiator 804 generates a second order differential signal Y_d2 of the luminance signal Y and a second order differential signal C_d2 of the chrominance signal C.

The edge chrominance signal generator 810 carries out multiplication on the sign value (Y_d1) of the first order differential signal Y_d1 of the luminance signal Y, the sign value (Y_d2) of the second order differential signal Y_d2 of the luminance signal Y, the first order differential signal C_d1 of the chrominance signal C and a gain constant to generate an edge chrominance signal C_e. The gain constant is −K in the example of FIG. 4.

The edge-improved chrominance signal generator 812 adds together the edge chrominance signal C_e and the chrominance signal C to generate an edge-improved chrominance signal C_ei. The chrominance signal minimum detector 806 detects a minimum value Cmin of the chrominance signal C from a positive section of the second order differential signal C_d2 of the chrominance signal C. The chrominance signal maximum value detector 808 detects a maximum value Cmax of the chrominance signal C from a negative section of the second order differential signal C_d2 of tile chrominance signal C.

The transition-improved chrominance signal generator 814 clamps the edge-improved chrominance signal C_ei to generate a transition-improved chrominance signal C_ti having a value between the minimum value Cmin and the maximum value Cmax of the chrominance signal C. Clamping in this exemplary embodiment means cutting off values lower than the minimum value Cmin of the chrominance signal and cutting off values higher than the maximum value Cmax of chrominance signal.

The transition-improved chrominance signal generator 814 outputs the minimum value Cmin of the chrominance signal C as the value of the transition-improved chrominance signal C_ti in a section where the value of the edge-improved chrominance signal C_ei is lower than the minimum value Cmin of the chrominance signal C in a positive section of the second order differential signal of the chrominance signal C. The transition-improved chrominance signal generator 814 outputs the edge-improved chrominance signal C_ei as the transition-improved chrominance signal C_ti in a section where the value of the edge-improved chrominance signal C_ei is higher than the minimum value Cmin of the chrominance signal C in the positive section of the second order differential value of the chrominance signal C. Furthermore, the transition-improved chrominance signal generator 814 outputs the maximum value Cmax of the chrominance signal C as the value of the transition-improved chrominance signal C_ti in a section where the value of the edge-improved chrominance signal C_ei is higher than the maximum value Cmax of the chrominance signal C in a negative section of the second order differential signal of the chrominance signal C. The transition-improved chrominance signal generator 814 outputs the edge-improved chrominance signal C_ei as the transition-improved chrominance signal C_ti in a section where the value of the edge-improved chrominance signal C_ei is lower than the maximum value Cmax of the chrominance signal in the negative section of the second order differential signal of the chrominance signal C.

As described above, the image signal processing apparatus according to an exemplary embodiment of the present invention generates the edge-improved chrominance signal C_ei using both the luminance signal Y and the chrominance signal C and generates the transition-improved chrominance signal C_ti by removing the undershoot aid overshoot of the edge-improved chrominance signal C_ei. The image signal processing apparatus of the exemplary embodiment of the present invention can be applied to the case where both the luminance signal Y and the chrominance signal C have a rising transient slope, to the case where the luminance signal Y has a rising transient slope and the chrominance signal C has a falling transient slope, to the case where the luminance signal Y has a falling transient slope and the chrominance signal has a rising transient slope, and to the case where both the luminance signal Y and the chrominance signal C have a falling transient slope.

According to an exemplary embodiment of the present invention, disharmony between the luminance signal and the edge-improved chrominance signal can be prevented by improving the edge characteristic of the chrominance signal using both the chrominance signal and the luminance signal correlated with the chrominance signal. Furthermore, the original image can be prevented from being distorted due to the undershoot and overshoot of the edge-improved chrominance signal by removing the undershoot and overshoot.

While the present invention has been particularly shown and described with reference to exemplary embodiments thereof, it will be understood by those of ordinary skill in the art that various changes in form and details may be made therein without departing from the spirit and scope of the present invention, as defined by the following claims.

What is claimed is:

1. A method of receiving an image signal including a luminance signal and a chrominance signal and outputting a transition-improved chrominance signal, the method comprising:
carrying out multiplication on the sign value of a first order differential signal of the luminance signal, the sign value of a second order differential signal of the luminance signal, a first order differential signal of the chrominance signal and a gain constant to generate an edge chrominance signal;
adding the edge chrominance signal and the chrominance signal to generate an edge-improved chrominance signal;
detecting a minimum value of the chrominance signal from a predetermined portion of a positive section of a second order differential signal of the chrominance signal, outputting the minimum value as the value of the transition-improved chrominance signal in a section where the value of the edge-improved chrominance signal is lower than the minimum value, and outputting the edge-improved chrominance signal as the transition-improved chrominance signal in a section where the value of the edge-improved chrominance signal is higher than the minimum value; and
detecting a maximum value of the chrominance signal from a predetermined portion of a negative section of the second order differential signal of the chrominance signal, outputting the maximum value as the value of the transition-improved chrominance signal in a section where the value of the edge-improved chrominance signal is higher than the maximum value, and outputting the edge-improved chrominance signal as the transition-improved chrominance signal in a section where the value of the edge-improved chrominance signal is lower than the maximum value.

2. The method of claim 1, wherein the gain constant is controlled according to a degree of the edge improvement of the chrominance signal.

3. The method of claim 1, wherein the predetermined portion of the positive section of the second order differential signal of the chrominance signal is determined according to characteristics of the luminance signal and the chrominance signal and the gain constant.

4. The method of claim 1, wherein the predetermined portion of the negative section of the second order differential signal of the chrominance signal is determined according to characteristics of the luminance signal and the chrominance signal and the gain constant.

5. The method of claim 1, wherein a discrete point of the edge chrominance signal corresponds to a point of inflection of the chrominance signal.

6. The method of claim 1, further comprising applying the method to the case where both the luminance signal and the chrominance signal have a rising transient slope, to the case where the luminance signal has a rising transient slope and the chrominance signal has a falling transient slope, to the case where the luminance signal has a falling transient slope and the chrominance signal has a rising transient slope, and to the case where both the luminance signal and the chrominance signal have a falling transient slope.

7. An apparatus receiving an image signal including a luminance signal and a chrominance signal and outputting a transition-improved chrominance signal, the apparatus comprising:
a first differentiator generating a first order differential signal of the luminance signal and a first order differential signal of the chrominance signal;
a second differentiator generating a second order differential signal of the luminance signal and a second order differential signal of the chrominance signal;
an edge chrominance signal generator carrying out multiplication on the sign value of the first order differential signal of the luminance signal, the sign value of the second order differential signal of the luminance signal, the first order differential signal of the chrominance signal and a gain constant to generate an edge chrominance signal;
an edge-improved chrominance signal generator adding the edge chrominance signal and the chrominance signal at generate an edge-improved chrominance signal;
a chrominance signal minimum value detector detecting a minimum value of the chrominance signal from a positive section of a second order differential signal of the chrominance signal;
a chrominance signal maximum value detector detecting a maximum value of the chrominance signal from a negative section of the second order differential signal of the chrominance signal; and
a transition-improved chrominance signal generator clamping the edge-improved chrominance signal to generate the transition-improved chrominance signal having a value between the minimum value and the maximum value of the chrominance signal.

8. The apparatus of claim 7, wherein, in the positive section of the second order differential signal of the chrominance signal, the transition-improved chrominance signal generator outputs the minimum value as the value of the transition-improved chrominance signal in a section where the value of the edge-improved chrominance signal is lower than the minimum value and outputs the edge-improved chrominance signal as the transition-improved chrominance signal in a section where the value of the edge-improved chrominance signal is higher than the minimum value.

9. The apparatus of claim 7, wherein, in the negative section of the second order differential signal of the chrominance signal, the transition-improved chrominance signal generator outputs the maximum value as the value of the transition-improved chrominance signal in a section where the value of the edge-improved chrominance signal is higher than the maximum value and outputs the edge-improved chrominance signal as the transition-improved chrominance signal in a section where the value of the edge-improved chrominance signal is lower than the maximum value.

10. The apparatus of claim 7, wherein the gain constant is controlled according to a degree of the edge improvement of the chrominance signal.

11. The apparatus of claim 7, wherein a discrete point of the edge chrominance signal corresponds to a point of inflection of the chrominance signal.

12. The apparatus of claim 7, wherein both the luminance signal and the chrominance signal have a rising transient slope.

13. The apparatus of claim 7, wherein the luminance signal has a rising transient slope and the chrominance signal has a falling transient slope.

14. The apparatus of claim 7, wherein the luminance signals has a falling transient slope and the chrominance signal has a rising transient slope.

15. The apparatus of claim 7, wherein both the luminance signal and the chrominance signal have a falling transient slope.
